(19) United States
(12) Patent Application Publication
(10) Pub. No.: US 2012/0151789 A1
(43) Pub. Date: Jun. 21, 2012

(54) STORAGE AND DRYING APPARATUS FOR FOOTWEAR AND APPAREL

(76) Inventor: John Hurst, Shorewood, IL (US)

(21) Appl. No.: 13/302,318

(22) Filed: Nov. 22, 2011

Related U.S. Application Data
(60) Provisional application No. 61/424,101, filed on Dec. 17, 2010.

(51) Int. Cl. F26B 25/06; F26B 25/10

(52) U.S. Cl. 34/202

(57) ABSTRACT

A storage and drying apparatus may comprise a base component, and storage and drying components. The storage and drying component may be a large footwear component, a small footwear component or an apparel component. Any combination of components may be used in connection with the apparatus. A drainage tray may be removeably carried by the base component. The storage and drying components may each include connecting pegs and corresponding connecting holes to receive the connecting pegs so that the storage and drying components may be securely and interchangeably stacked.

### RELATED APPLICATION

The present application claims the benefit of U.S. Provisional Patent Application Ser. No. 61/424,101 titled STORAGE AND DRYING APPARATUS FOR FOOTWEAR AND APPAREL filed by the inventor of the present invention on Dec. 17, 2010, the entire contents of which are incorporated herein by reference.

### Field of the Invention

This invention relates to the field of storage apparatuses and, more specifically, to the field of storage apparatuses that store footwear and apparel, allowing moisture and debris to drain off items contained within the apparatus, and collecting the debris in a removable tray for facilitated disposal of the removed moisture or debris.

### BACKGROUND OF THE INVENTION

Inclement weather conditions can cause footwear to become covered in mud, snow, and other elements. These elements can then be carried into public buildings or private homes, at times creating a nuisance and potential safety hazard. Additionally, footwear storage for large families can be difficult to manage, This issue is enhanced when each family member owns more than one pair of footwear or apparel, Footwear can often collect in a closet or foyer, clutter floors, and distribute slush, water, mud, or other debris to the area adjacent to where footwear is stored.

Presently, racks exist that are used to store and drain moisture from footwear, apparel, and other items. For example, U.S. Pat. No. 1,661,098 to Side and U.S. Pat. No. 3,762,573 to Collins at al. recite racks used to store and drain moisture from overshoes, but require the overshoes to be inserted into the rack upside down, thereby resulting in the upper portion of the overshoes being soiled during the draining process. In another example, U.S. Pat. No. 1,810,308 to Wandeler and U.S. Pat. No. 3,311,242 to Miklya recite racks that allow moisture to drain from footwear and into a tray, but these racks are not stackable or otherwise connectedly expandable. U.S. Pat. No. 3,587,864 to Delisle provides a rack with expandability, but such expandability requires a confusingly large number of panels that a user is required to connect using an array of prongs and fitted slots.

U.S. Pat. No. 4,200,993 to Blanc et al. recites a structure with branching vertically arranged pegs, wherein moisture and debris on the footwear placed on the upper pegs soils the footwear placed on the lower pegs below. Further, the Blanc et al, '993 patent requires the use of an electric blower to dry the footwear. U.S. Pat. No. 4,997,093 to Letteri, Jr, provides a rack to drain moisture from footwear into a tray, but is not expandable. Further, the Letteri, Jr, '093 patent requires mounting the rack on a baseboard heater, rendering such a rack useless in households that do not use baseboard heaters. U.S. Design Patent No. D324,787 to Evans discloses a vertically stackable shoe rack, but includes an open mesh, which results in drained moisture and debris soiling the items and floor located below the items being drained.

U.S. Pat. No. 6,772,889 to Moceri discloses a shelf structure for holding wet apparel, but requires the structure to be mounted to a wall. U.S. Patent Application Publication No. 2006/0091087 to Belanger et al. recites a footwear rack wherein footwear can be placed on two different levels simultaneously, but is not stackable or expandable. Finally, U.S. Pat. No. 7,766,174 to Abraitis recites stackable shelves which drain into a base, but the shelves are stacked on legs and provide an open view of the soiled footwear, which many consumers would find too visually unappealing to have in their homes. Further, since the Abraitis '174 patent requires the use of numerous legs and shelves to expand, the number of parts to assemble and manage can quickly become staggering to an end consumer.

With the above in mind, a need exists for an expandable drying apparatus which will efficiently store a plurality of footwear and apparel and allow the plurality of footwear and apparel to dry. There also exists a need for an expandable drying apparatus that includes a plurality of components that may be stacked or expanded, contains a removable drainage receptacle, is simple to assemble and use, is easy to clean, and can be affordably manufactured in a variety of colors and materials to accommodate different home decor and styles.

### SUMMARY OF THE INVENTION

The storage and drying apparatus according to an embodiment of the present invention provides for efficient storage and drying capabilities for footwear and apparel that may be stored therein. The apparatus according to an embodiment of the present invention also advantageously provides a plurality of components that may be vertically expanded, contains a removable drainage receptacle, is simple to assemble and use, is easy to clean, and can be affordably manufactured in a variety of colors and materials to accommodate different home decor and styles.

Accordingly, the present invention advantageously provides a storage and drying rack for footwear and apparel that is efficient in its use of space. The storage and drying rack of an embodiment of the present invention is also advantageously expandable in its capacity to store footwear and apparel, as the need for additional storage and drying capacity may demand. The storage and drying rack of an embodiment of the present invention further advantageously can be easily and affordably manufactured in a plurality of colors, and is simple in its design, usage, and cleanup. Other advantages of one or more aspects of the present invention will be apparent to a skilled artisan after consideration of the drawings and accompanied descriptions.

These and other objects, features and advantages according to an embodiment of the present invention are provided by a storage and drying apparatus for footwear and apparel that may comprise a base component and at least one storage and drying component. The storage and drying component may include a large footwear component, a small footwear component, and/or an apparel component. The base component may include a top component panel, a component floor surface, component wall panels, and a drainage tray that may be rernoveably carried by the base component. The large footwear component may include an opening adjacent a front portion thereof, a top component panel, a component floor surface, a bottom component panel, and component wall panels. The small footwear component may include an opening adjacent a front portion thereof that is smaller than the opening adjacent the front portion of the large footwear component, a top component panel, a component floor surface, a bottom component panel, and component wall panels. The apparel component may include a component floor surface, a component bottom panel, and component wall panels.

The large footwear component, the small footwear component and the apparel component may each include connecting pegs that extend from a bottom portion thereof. The top component panel of each of the base component, the large footwear component, and the small footwear component may have corresponding connecting holes to receive the connecting pegs so that the base component, the large footwear component, the small footwear component and the apparel component may be securely and interchangeably stacked with respect to one another in a substantially vertical configuration.

In some embodiments of the storage and drying apparatus according to the present invention, the component floor surface of each of the large footwear component, the small footwear component and the apparel component may include a drainage port, The bottom component panel of each of the large footwear component, the small footwear component and the apparel component may include a drainage coupler positioned to underlie the drainage port. The drainage coupler on each of the base component, the apparel component, the large footwear component, and the small footwear component may interconnect so as to create a continuous drainage pathway.

In some embodiments of the storage and drying apparatus according to the present invention, the component wall panels on a rear surface and side surfaces of each of the large footwear component, the small footwear component, and the apparel component may have a plurality of holes formed therein, A handle may be connected to the drainage tray. One handle may be located adjacent a front portion of the drainage tray and a handle may be located adjacent a rear portion of the drainage tray. The handles may be hingedly connected to the drainage tray. The drainage tray may include at least one divider. The drainage tray may include a flow port. A drainage flange may be carried by the base component to underlie the drainage pathway to define an inclined surface for distribution of moisture and debris in the drainage tray. A plurality of support members may be attached to a bottom surface of the base component.

### BRIEF DESCRIPTION OF THE DRAWINGS

FIG. 1 is a front perspective view of a drying apparatus including multiple stackable components according to an embodiment of the present invention.

FIG. 2 is a front elevation view of the drying apparatus illustrated in FIG. 1.

FIG. 3 is a side elevation view of the drying apparatus illustrated in FIG. 1.

FIG. 4 is a rear elevation view of the drying apparatus illustrated in FIG. 1.

FIG. 5 is a top plan view of a component top of the drying apparatus illustrated in FIG. 1 having multiple support holes.

FIG. 6 is a bottom plan view of a component bottom of the drying apparatus illustrated in FIG. 1 having multiple support pegs.

FIG. 7 is an exploded front elevation of the drying apparatus illustrated in FIG. 1.

FIG. 8 is a top plan view of a drainage tray of the drying apparatus according to an embodiment of the present invention.

FIG. 9 is a top plan view of an apparel component of the drying apparatus according to an embodiment of the present invention wherein the top portion is open to receive footwear or apparel.

FIG. 10 is a front elevation view of a component of the drying apparatus according to an embodiment of the present invention having a plurality of holes formed therein to allow for drying.

FIG. 11 is a side elevation view of a component of the drying apparatus according to an embodiment of the present invention having a plurality of holes formed therein to allow for drying.

FIG. 12 is a perspective view of a drainage tray of the drying apparatus according to an embodiment of the present invention and having a plurality of dividers; and

FIG. 13 is a top plan view of an apparel component of the drying apparatus according to an embodiment of the present invention wherein the lip is shown.

### DETAILED DESCRIPTION OF THE INVENTION

The present invention will now be described more fully hereinafter with reference to the accompanying drawings, in which preferred embodiments of the invention are shown, This invention may, however, be embodied in many different forms and should not be construed as limited to the embodiments set forth herein. Rather, these embodiments are provided so that this disclosure will be thorough and complete, and will fully convey the scope of the invention to those skilled in the art. Like numbers refer to like elements throughout.

In this detailed description of the present invention, a person skilled in the art should note that directional terms, such as “above,” “below,” “upper,” “lower,” and other like terms are used for the convenience of the reader in reference to the drawings. Also, a person skilled in the art should notice this description may contain other terminology to convey position, orientation, and direction without departing from the principles of the present invention.

Embodiments of the present invention are described herein using the context of an apparatus for drying and storage of footwear and apparel. Those of ordinary skill in the art will realize that the following embodiments of the present invention are only illustrative and are not intended to be limiting in any way. Other embodiments of the present invention will readily suggest themselves to such skilled persons having the benefit of this disclosure.

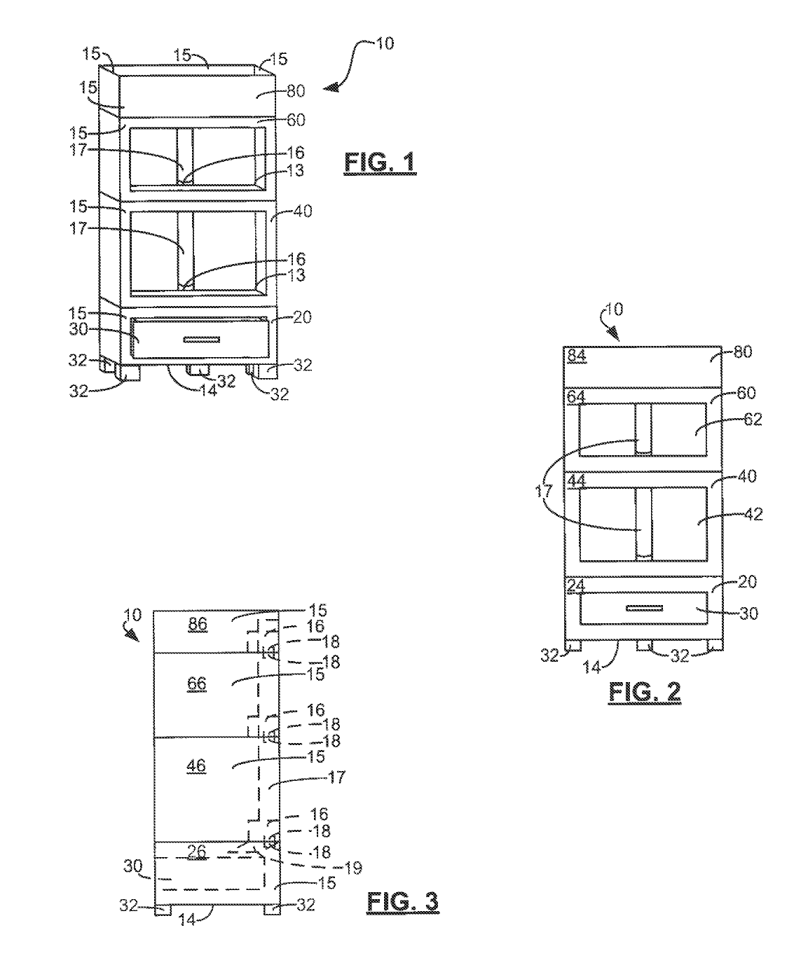

FIG. 1 is a front perspective view of a storage and drying apparatus 10 for footwear and apparel according to an embodiment of the present invention, and illustrates generally the components of a preferred embodiment for the apparatus 10, As illustrated in FIGS. 1-4, the apparatus 10 is constructed from a collection of components. More specifically, the apparatus 10 generally comprises a base component 20, a large footwear component 40, a small footwear component 60, and an apparel component 80. A skilled artisan, after having the benefit of this disclosure, will realize that the size, shape, and number of components may vary and still remain within the scope and spirit of the present invention. The components are designed with the structural capacity adequate to provide support for multiple additional components as they are stacked vertically.

The base component 20 of the present invention generally includes a top component panel 12 (FIG. 5), component wall panels 15 (FIG. 3), and a base bottom panel 14. Preferably, the base bottom panel 14 includes a solid surface that prevents moisture or debris from leaking on to a floor surface upon which the apparatus 10 is positioned, or other horizontal surface whereon the apparatus is placed. A person of skill in the art will realize, however, that additional embodiments of the base bottom panel 14 may include holes, ports, or other similar features.

The large footwear component 40 and small footwear component 60 of the apparatus 10 according to an embodiment of the present invention generally each include a top component panel 12 (FIG. 5), a bottom component panel 14 (FIG. 6), and component wall panels 15 (FIG. 3). The apparel component 80 may generally include a component bottom panel 14 (FIG. 6) and component wall panels 15 (FIG. 3), leaving the top portion of the apparel component 80 open to receive apparel and other items. As further illustrated in FIG. 9, the absence of a component top panel 12 in the apparel component 80 may leave the component floor surface 13 exposed vertically. As a result, items could be placed directly on the component floor surface 13 of the apparel component 80 by vertically descending them in the apparel component 80.

In a preferred embodiment of the apparatus 10 of the present invention, the component panels may be rigidly attached to each other to construct a structurally stable component. A skilled artisan will realize alternate attachment methods, such as, for example, removable panels, which still remain within the scope and spirit of an embodiment of the present invention. The top component panels 12 may feature at least one connecting hole 36 (FIG. 5), which may be designed to receive at least one connecting peg 34 (FIG. 6) located on the bottom component panel 14. By interlocking the connecting pegs 34 of the bottom component panel 14 with the connecting holes 36 of the top component panel 12, two components can readily be securely interconnected to one another with a high degree of stability. Although five connecting pegs 34 and five connecting holes 36 are illustrated in the appended figures, those skilled in the art will appreciate that any number of connecting pegs 34 and connecting holes 36 may be provided while simultaneously achieving the goals, features, and objectives according to an embodiment of the present invention. A skilled artisan, after having the benefit of this disclosure, will realize that the number of connecting pegs 34 preferably corresponds with the number of connecting holes 36.

As perhaps best illustrated in FIG. 7, the base component 20 may be placed on a relatively flat horizontal surface, such that the connecting holes 36 of the top component panel 12 face upward. At least one of the storage and drying components which may, for example, be selected from the group consisting of a large footwear component 40, a small footwear component 60 and an apparel component 80 may be positioned to overlie the base component 20. More particularly, the connecting pegs 34 on the bottom component panel 14 of the large footwear component 40, small footwear component 60, and apparel component 80 may be matingly fitted into and, interlock with, the connecting holes 36 on the base component 20. Similarly, the connecting pegs 34 on the bottom component panel 14 of the aforementioned components may be matingly fitted into, and interlocked with, any component that includes a top component panel 12 and connecting holes 36, The interlocking of the connecting pegs 34 into the connecting holes 36 advantageously provides enhanced stability as the components are stacked vertically.

A drainage coupler 18 may preferably be located on the top component panel 12 and bottom component panel 14 of each component featuring such panels, allowing the interconnection of the components. The drainage coupler 18 on the top surface of the lower component may be operatively connected to the drainage coupler 18 on the bottom surface of the upper component. The interconnection of drainage couplers 18 creates a continuous drainage pathway 17 between each component, which advantageously leads to the drainage tray 30, located in the base component 20. A drainage flange 19 (FIG. 3) may be located within the base component 20, at the bottom of the drainage pathway 17. The drainage flange 19 may provide a widening, inclined surface at the bottom of the drainage pathway 17, so that the moisture and debris removed during operation of the apparatus 10 may be evenly distributed into the drainage tray 30. Those skilled in the art will appreciate, however, that the description of the inclined surface at the bottom of the drainage pathway 17 is exemplary, and the surface of the bottom of the drainage pathway may have any shape, incline or angle. The drainage flange 19 may direct the moisture and debris to a position in the base component 20, located vertically above the drainage tray 30, allowing more uniform distribution of moisture or debris into the drainage tray 30. The drainage flange 19 preferably directs the moisture and debris towards the center of the base component 20, but a skilled artisan will realize any position, or multiple positions, above the drainage tray 30 shall be included within embodiments of the present invention.

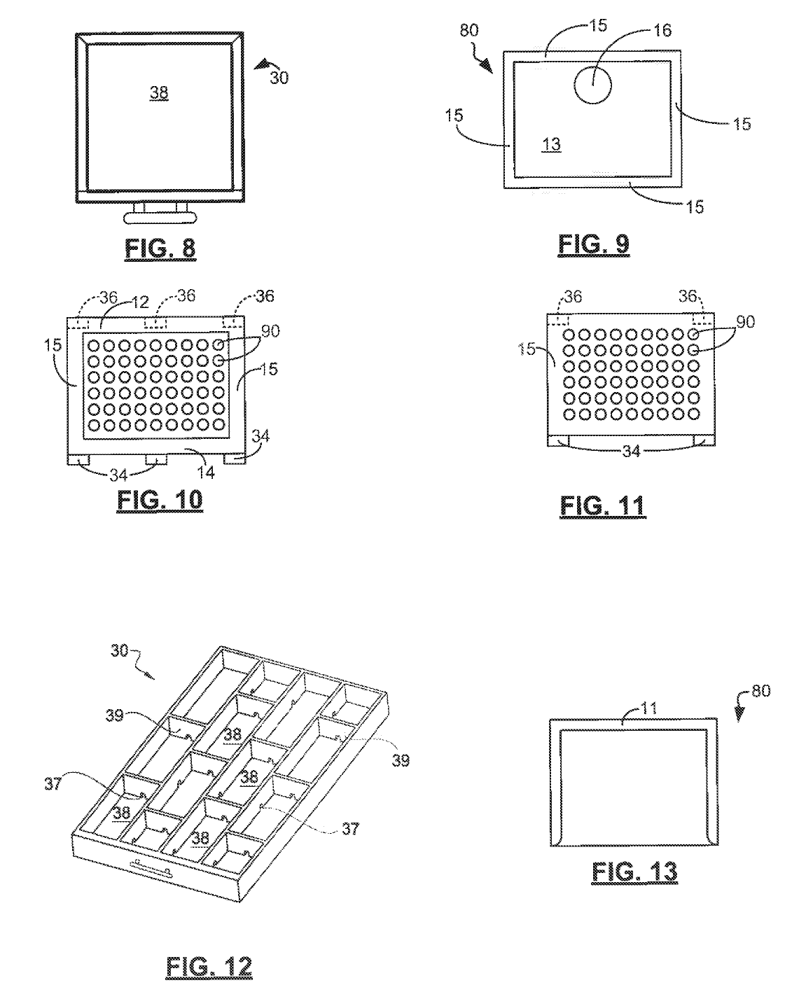

Moisture and debris captured from footwear, apparel, and other items stored in the apparatus 10 may drain through a drainage port 16 located on the component floor surface 13 of a component. After draining into the drainage port 16, the moisture or debris may enter the drainage pathway 17. The drainage pathway 17 may preferably continue through each component, interlinked at the drainage couplers 18 located on the component top panels 12 and component bottom panels 14 of the various components that comprise the apparatus 10. An exemplary drainage coupler 18 connective structure, which creates the drainage pathway 17, is illustrated, for example, in FIG. 3. The drainage tray 30 is illustrated in FIG. 8 and will be discussed in greater detail below.

If additional components are desired, the additional components can be stacked above or between existing components, preferably interlocking the connecting pegs 34, on the bottom component panel 14, of the upper component with the connecting holes 36, on the top component panel 12, of the lower component. Further, the drain couplers 18 of the upper and lower components may be operatively connected to one another to ensure that debris and excess moisture from items stored within each compartment are moved through the drainage pathway 17 and into the drainage tray 30. Additional components may be stacked on top or between existing components until the desired number of components has been reached. Due to its open top, the apparel component 80 is preferably positioned as the top component, if included in the advantageously customizable apparatus 10.

Referring back to FIGS. 1-4, the apparatus 10 according to an embodiment of the present invention is now described in greater detail. The apparatus 10 is preferably assembled with its multiple components stacked vertically. First, in a preferred embodiment, the present invention may include a base component 20 at the bottom of the apparatus 10. The base component 20 may further include a top component panel 12, a base bottom panel 14, component wall panels 15, a base front surface 24, base side surfaces 26, and a base rear surface 28. A person of skill in the art will realize that any number and combination of large footwear components 40 and/or small footwear components 60 can be used and still remain within the scope and spirit of the present invention. Also, a skilled artisan will realize that the absence of one component type of apparatus 10, or addition of a variation of a disclosed component, should be considered part of this disclosure of the present invention.

In one present embodiment of the apparatus 10 according to the present invention, the base component 20 may be shaped as a rectangular box and may be horizontally positioned to facilitate the placement of the apparatus approximately parallel to a horizontal supporting surface. Although a rectangular box is illustrated and disclosed, a skilled artisan will realize that the apparatus 10 can be constructed in a variety of shapes and maintain the same functionality. Examples of horizontal supporting surfaces may include floors, porches, earth, platforms, shelves, tables or other relatively flat surfaces. A person of skill in the art will further realize that the apparatus can be placed in other additional suitable locations. It should be noted, however, that although it is preferred that the apparatus 10 be positioned on a substantially flat surface, it is contemplated that the apparatus can be positioned on a slanted surface while still accomplishing the goals, features, and advantages according to the present invention. In fact, it may be desirable in some cases to position the apparatus 10 on a slightly slanted surface to enhance drainage of debris and fluid from therein.

The base component 20 may have an opening in the component wail panel 15 on the base front surface 24 for the placement of a removable drainage tray 30, as illustrated, for example, in FIG, 8. A user of the apparatus 10 may access the drainage tray 30 by slidably removing the drainage tray 30 from the base component 20 through the opening in the component wall panel 15 on the base front surface 24. In one embodiment, the drainage tray 30 may be structured as a drawer. The drainage tray 30 may be provided, for example, by a drawer and may be supported by rails that are operatively connected to the inside surfaces of the component wall panels 15 that form the base component 20. Supporting the drainage tray 30 using rails may facilitate removal of the drainage tray by providing for slidable, horizontal movability of the drainage tray. A person of skill in the art, after having the benefit of this disclosure, will realize additional configurations that allow the drainage tray 30 to be removed from the base component 20 of the apparatus 10 that are consistent with the scope and spirit of the present invention.

The base component 20 may further comprise a drainage coupler 18 located on the top component panel 12 of the base component 20, by which the drainage coupler 18 on the bottom component panel 14 of an additional component, located directly above the base component 20, can be operatively connected. Preferably, all components of the apparatus 10 share a common drainage system, using an interconnected drainage pathway 17 connected using the drainage couplers 18, for the removal of moisture and debris from the components of the apparatus 10 to the drainage tray 30,

The drainage tray 30 may be configured as a removable drawer that passes through the component wall panel 15 on the base front surface 24 of the base component 20. While in the closed position, the removable drainage tray 30 may extend inward from the opening on the base front surface 24 into the body of the base component 20 to be approximately adjacent to the component wall panel 15 on the base rear surface 28 of the base component 20, filling substantially the entire depth of the base component 20. The drainage tray 30 may be positioned to capture the drainage produced during the drying and storage of the footwear and apparel on the tray floor surface 38. A person of skill in the art will realize that alternate dimensions and configurations of the drainage tray 30 may be implemented that remain within the scope and spirit of the present invention.

As further Illustrated in FIGS, 1-9, a large footwear component 40 generally comprises a top component panel 12, a component floor surface 13, component wall panels 15, a bottom component panel 14, large footwear front surface 44 large footwear side surfaces 46, and large footwear rear surface 48. The large footwear component 40 may further feature a large footwear opening 42 in the component wall panel 15 on the large footwear front surface 44. Preferably, the large footwear opening 42 is dimensionally sufficient to accommodate large footwear such as boots, galoshes, overshoes, or other large items. A person of skill in the art will further realize that additional objects can be placed in the large footwear opening 42 of the large footwear component 40 that fit adequately within the dimensions of the large footwear component 40. The large footwear component 40 is preferably configured to be the same shape as the base component 20 to facilitate stacking and interoperability of the multiple components.

As further illustrated in FIGS, 1-9, the apparatus 10 may include a small footwear component 60. The small footwear component 60 generally comprises a top component panel 12, a component floor surface 13, a bottom component panel 14, component wall panels 15, a small footwear front surface 64, small footwear side surfaces 66, and a small footwear rear surface 68. Similar to the large footwear component 40, the small footwear component 60 may feature a small footwear opening 62 in the component wall panel 15 on the small component front surface 64. Preferably, the small footwear opening 62 is dimensionally sufficient to accommodate small footwear such as shoes, sandals, low tops, and other similar sized items. A person of skill in the art will also realize that objects other than small footwear may be dried or stored in the small footwear component 60 and remain within the scope and spirit of the present invention, The small footwear component 60 is also preferably configured to be the same shape as the base component 20 to allow stacking and interoperability of the multiple components.

The apparel component 80 of the apparatus 10 according to an embodiment of the present invention may generally comprise a component floor surface 13, a bottom component panel 14, component wall panels 15, an apparel front surface 84, apparel side surfaces 86, and an apparel rear surface 88. The apparel component 80 may also include an open top that advantageously allow for apparel and other objects to be readily placed therein for drying or storage. The apparel component 80 may also feature a plurality of component wall panels 15 that enclose the component floor surface 13. The component wall panels 15 of the apparel component 80 are preferably of a height sufficient to secure articles placed within the apparel component 80 from falling off the apparatus 10. The apparel component 80 according to an embodiment of the apparatus 10 may also include a component floor surface 13 that is not enclosed by component wall panels 15, forming an area that may resemble a table-top, for example, for the placement of articles that may require the storage or drying features of the present invention.

A person of skill in the art will realize that a plurality of additional components may be located between the base component 20 and the open top component, which, in the present embodiment, is an apparel component 80. Those skilled in the art will also appreciate that the apparel component 80 may include a lip portion 11 adjacent to an outer peripheral portion of the component floor surface 13, as shown in FIG. 13. The lip portion 11 may be similar to the component wall panels 15, but may have a lower height to provide a barrier so that items positioned on the apparel component 80 may be secured therein.

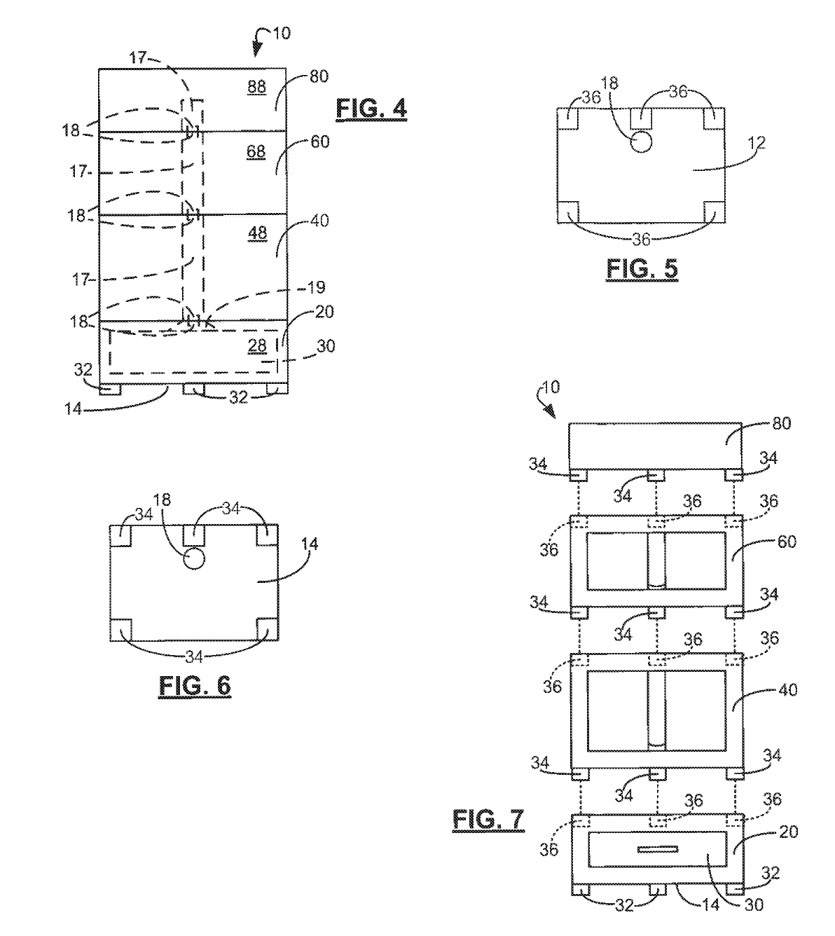

FIG. 9 illustrates a plan view of the apparel component 80, which further illustrates the component floor surface 13 of the various components included in the present invention, The component floor surface 13 of each component is preferably inclined, slanted, or otherwise configured such that moisture and debris removed from the footwear and apparel may be readily channeled to a drainage port 16. The drainage port 16 may then connect to the drainage pathway 17 of the apparatus 10 (see also FIGS. 3-4). The drainage pathway 17 advantageously allows the passage of moisture and debris from each component to the drainage tray 30, which is contained within the base component 20. As previously mentioned, each component may be interconnected using the drainage couplers 18, so that the collection of the linked drainage couplers 18 creates the drainage pathway 17. A person of skill in the art will realize that drainage ports 16, drainage couplers 18, and drainage pathway 17 can be located at any position along the component floor surface 13, and in any location on or within the component wall panels 15, of a component and still transport the moisture and debris drained from the footwear or apparel to the drainage tray 30.

The storage and drying apparatus for footwear and apparel 10 may be used to remove moisture and debris from footwear and apparel contained therein. The following is an illustrative example of the operation of the apparatus 10 according to an embodiment of the present invention.

When using the apparatus 10 according to an embodiment of the present invention, footwear and apparel may be stored in a component of adequate dimensions to accommodate the footwear or apparel. Moisture or debris, such as slush, sand, water, or other impurities, may fall from footwear and onto the inclined component floor surface 13. Thereafter, the moisture or debris may be carried by gravity, across the inclined component floor surface 13, to the drainage port 16. Once the moisture or debris enters the drainage port 16, it may be transmitted to, and carried through, the drainage pathway 17. The moisture and debris may then travel through each lower component, ultimately reaching the drainage tray 30. The drainage pathway 17 may allow for drainage from footwear or apparel on one level to be deposited into the drainage tray 30 without contaminating the footwear or apparel deposited on a lower level component. The drainage pathway 17 deposits the moisture and debris into the drainage tray 30 through an opening.

Once the drainage tray 30 has been filled with moisture and debris generated during the drainage process, a user can remove the drainage tray 30 from the base component 20 for disposal of the contents stored therein. Once the drainage tray 30 has been emptied, it may be reinserted into the base component 20 of the apparatus 10. Further, while the drainage tray 30 is removed from the base component 20, a user may clean the drainage tray 30 using a garden hose, cloth, or other method of cleaning known by a skilled artisan. Accordingly, it is preferable that the drainage tray 30 be made of a material that is suitable to be wet without causing damage thereto,

In an additional embodiment, the component floor surface 13 of a component may be spiked or slotted, in addition to being angled, to provide a component floor surface 13 that facilitates the collection of moisture and debris falling off the footwear and apparel positioned therein. In another embodiment, the component floor surface 13 may be constructed with channeled grooves.

Supporting feet 32 may be attached to the bottom base panel of the base component 20. A person of skill in the art will realize, after having the benefit of this disclosure, that the number of supporting feet 32 can be any number sufficient to stably support the apparatus 10. As such, the number of supporting feet 32 that may be attached to the bottom base panel of the base component 20 is not required to be the same as the number of connecting pegs 34 that may be attached to the bottom component pan& 14 of other components. The supporting feet 32 of the base component 20 may contact the floor, or other surface to which the apparatus 10 is located. A person of skill in the art will realize additional configurations in which the apparatus 10 operatively contacts with the floor surface.

The base component 20, the large footwear component 40, small footwear component 60, the apparel component 80, and the removable drainage tray 30 may be constructed from a molded, water impervious material. Such materials may include, for example, plastics, nylon, plasticized materials, non corrosive metals, or any combination thereof. A person of skill in the art will realize that the components of the apparatus 10 may be constructed from any combination of named and additional materials and still remain within the scope and spirit of the present invention. Additionally, the apparatus 10 can be made in a variety of colors to coordinate with a user's footwear, apparel, preferences, tastes, or for home decorum purposes.

In an additional embodiment, as illustrated in FIGS. 10 and 11, one or multiple components may include a plurality of holes 90, or passageways, formed in the component wall panels 15 on the rear surfaces 48, 68, and 88 and a plurality of holes 90, or passageways, formed in the component wall panels 15 on side surfaces 46, 66, and 86 that allow additional airflow and enhance drying capabilities.

As perhaps best illustrated in FIG. 12, the removable drainage tray 30 may include dividers 39 that separate the tray into individual compartments. The tray may include flow ports 37, The flow ports 37 advantageously avow liquid to drain from one individual compartment to another, reduce splashing during transport for disposal, and increase the rigidity of the drainage tray 30.

The drainage tray 30 may also include a carrying handle. The carrying handle may be located on any vertical panel of the drainage tray, including, but not limited to, the front, sides, or rear panels of the drainage tray 30. The drainage tray 30 may feature a plurality of handles on opposing vertical panels of the drainage tray 30, allowing the drainage tray 30 to be easily carried to a location suitable for disposing the contents located therein.

The carrying handle may, for example, be provided by a fold-down handle that allows for the removable drainage tray 30 to be moved, or carried to a location where the drainage contents may be disposed of, The fold-down handle may include hinge points on the surface of the drainage tray 30, which may connect with the carrying handle, allowing the fold-down handles to be rotated about an axis that runs through the hinge point. Rotation about the hinge point allows the carrying handle to occupy less space on the horizontal plane that is approximately parallel to the drainage tray 30, as the drainage tray 30 is inserted into the base component 20. The inclusion of a fold-down handle allows the carrying handle to occupy less space when placed within the base component 20, thereby allowing the drainage tray 30 to occupy a larger area when located within the base component 20.

Additional details of the storage and drying apparatus 10 according to an embodiment of the present invention are now provided. As illustrated in FIGS. 1-4 and 7, and as described above, the apparatus 10 may comprise a base component 20, and a storage and drying component. The storage and drying component may, for example, be a large footwear component 40, a small footwear component 60 or an apparel component 80. Those skilled in the art will appreciate that any combination of components can be used in connection with the apparatus according to an embodiment of the present invention. A drainage tray 30 may be removeably carried by the base component 20.

As perhaps best illustrated in FIGS. 5 and 6, the large footwear component 40, the small footwear component 60 and the apparel component 80 may each include connecting pegs 34 extending from a bottom portion thereof. The top component panel 12 of each of the base component 20, the large footwear component 40, and the small footwear component 60 may have connecting holes 36 to receive the connecting pegs 34 so that the base component, the large footwear component, the small footwear component and the apparel component 80 may be securely and interchangeably stacked in a substantially vertical configuration. Accordingly, the apparatus 10 according to an embodiment of the present invention advantageously allows for each of the components to be readily stackable so as to provide space saving solutions for the storage and drying of footwear and apparel. A skilled artisan, after having the benefit of this disclosure, will realize that the number of connecting pegs 34 preferably corresponds with the number of connecting holes 36.

The component floor surface 13 of each of the large footwear component 40, the small footwear component 60 and the apparel component 80 may include a drainage port 16 (FIG. 9). The bottom component panel 14 of the large footwear component 40, the small footwear component 60 and the apparel component 80 may include a drainage coupler 18 that underlies the drainage port 16. The drainage coupler 18 on each of the base component 20, the apparel component 80, the large footwear component 40, and the small footwear component 60 may interconnect so as to create a continuous drainage pathway 17.

In some embodiments of the apparatus 10 according to the present invention, the component wall panels 15 on a rear surface 48 and side surfaces 46 of each of the large footwear component 40, the small footwear component 60, and the apparel component 80 may have a plurality of holes 90 formed therein (FIGS. 10 and 11). As illustrated in FIGS. 8 and 12, at least one handle may be connected to the drainage tray 30. One handle may be formed adjacent a front portion of the drainage tray 30 and one handle may be formed adjacent a rear portion of the drainage tray. The handles may be hingedly connected to the drainage tray 30. The drainage tray 30 may include dividers 39. The drainage tray 30 may include at least one flow port 37. A drainage flange 19 may be carried by the base component 20 to underlie the drainage pathway 17 to define an inclined surface for distribution of moisture and debris in the drainage tray 30. A plurality of support members 32 may be attached to a bottom surface of the base component 20.

After reading the disclosure of the present invention, it will become evident that the described drying apparatus 10 possesses many advantages over the prior art. The apparatus 10 is easily expandable to accommodate additional footwear or apparel, making efficient use of the small area the apparatus 10 occupies. All footwear stored within the apparatus 10 is protected from debris or materials that may drip or fall from footwear and apparel stored at higher levels. The inclusion of multiple sized components improves the spatial efficiency of the apparatus 10, providing a large volume of drying space without occupying a large area.

Accordingly, after having the benefit of this disclosure, the reader will realize the apparatus 10 of the disclosed invention can be used to easily and conveniently store wet or soiled footwear and apparel. Further, the present invention is easily expandable to accommodate a plurality of footwear and apparel, can be manufactured in different colors for easier footwear location identification or for accessorizingimatching home decorum, and contains a removable drainage tray 30 for easy disposal of matter from soiled footwear. Finally, the containers are easily removed, can be easily cleaned, and then replaced for continued use in drying and storing footwear and apparel.

Many modifications and other embodiments of the invention will come to the mind of one skilled in the art having the benefit of the teachings presented in the foregoing descriptions and the associated drawings. Therefore, it is understood that the invention is not to be limited to the specific embodiments disclosed.

That which is claimed is:

1. A storage and drying apparatus comprising:
a base component including a top component panel, a component floor surface, and component wail panels;
at least one storage and drying component selected from the group consisting of a large footwear component, a small footwear component and an apparel component; and
a drainage tray removeably carried by the base component;
wherein the large footwear component includes an opening adjacent a front portion thereof, a top component panel, a component floor surface, a bottom component panel, and component wall panels;
wherein the small footwear component includes an opening adjacent a front portion thereof that is smaller than the opening adjacent the front portion of the large footwear component, a top component panel, a component floor surface, a bottom component panel, and component wall panels;
wherein the apparel component includes a component floor surface, a component bottom panel, and component wail panels;
wherein the large footwear component, the small footwear component and the apparel component each includes at least one connecting peg extending from a bottom portion thereof; and
wherein the top component panel of each of the base component, the large footwear component, and the small footwear component has at least one connecting hole to receive the at least one connecting peg so that the base component, the large footwear component, the small footwear component and the apparel component may be securely and interchangeably stacked in a substantially vertical configuration.

2. A storage and drying apparatus according to claim 1 wherein the component floor surface of each of the large footwear component, the small footwear component, and the apparel component includes a drainage port.

3. A storage and drying apparatus according to claim 2 wherein the bottom component panel of each of the large footwear component, the small footwear component, and the apparel component includes a drainage coupler positioned to underlie the drainage port.

4. A storage and drying apparatus according to claim 3 wherein the drainage coupler on each of the base component, the apparel component, the large footwear component, and the small footwear component interconnects so as to create a continuous drainage pathway.

5. A storage and drying apparatus according to claim 1 wherein the component wall panels on a rear surface and side surfaces of each of the large footwear component, the small footwear component, and the apparel component have a plurality of holes formed therein.

6. A storage and drying apparatus according to claim 1 further comprising at least one handle connected to the drainage tray.

7. A storage and drying apparatus according to claim 1 wherein the drainage tray includes at least one divider,

8. A storage and drying apparatus according to claim 1 wherein the drainage tray includes at least one flow port.

9. A storage and drying apparatus according to claim 4 further comprising a drainage flange carried by the base component to underlie the drainage pathway to define an inclined surface for distribution of moisture and debris in the drainage tray.

10. A storage and drying apparatus according to claim 1 further comprising a plurality of support members attached to a bottom surface of the base component.

11. A storage and drying apparatus comprising:
a base component including a top component panel, a component floor surface, component wall panels and a plurality of support members attached to a bottom surface of the base component;
at least one large footwear component including a top component panel, a component floor surface, a bottom component panel, and component wall panels;
at least one small footwear component including a top component panel, a component floor surface, a bottom component panel, and component wall panels;
at least one apparel component including a component floor surface, a component bottom panel, and component wall panels; and
a drainage tray removeably carried by the base component;
wherein the large footwear component includes an opening adjacent a front portion thereof;
wherein the small footwear component includes an opening adjacent a front portion thereof that is smaller than the opening adjacent the front portion of the large footwear component;
wherein the large footwear component, the small footwear component and the apparel component each includes at least one connecting peg extending from a bottom portion thereof;
wherein the top component panel of each of the base component, the large footwear component, and the small footwear component has at least one connecting hole to receive the at least one connecting peg so that the base component, the large footwear component, the small footwear component and the apparel component may be securely and interchangeably stacked in a substantially vertical configuration;
wherein the component floor surface of each of the large footwear component, the small footwear component, and the apparel component includes a drainage port;
wherein the bottom component panel of each of the large footwear component, the small footwear component, and the apparel component includes a drainage coupler positioned to underlie the drainage port; and
wherein component Wail panels on a rear surface and side surfaces of at least one storage and drying component selected from the group consisting of the large footwear component, the small footwear component, and the apparel component include a plurality of holes formed therein.

12. A storage and drying apparatus according to claim 11 wherein the drainage coupler on each of the base component, the apparel component, the large footwear component, and the small footwear component interconnects so as to create a continuous drainage pathway.

13. A storage and drying apparatus according to claim 11 further comprising at least one handle connected to the drainage tray.

14. A storage and drying apparatus according to claim 11 wherein the drainage tray includes at least one divider.

15. A storage and drying apparatus according to claim 11 wherein the drainage tray includes at least one flow port.

16. A storage and drying apparatus according to claim 12 further comprising a drainage flange carried by the base component to underlie the drainage pathway to define an inclined surface for distribution of moisture and debris in the drainage tray.

17. A storage and drying apparatus comprising:
a base component including a top component panel, a component floor surface, component wall panels and a plurality of support members attached to a bottom surface of the base component;
at least one large footwear component including a top component panel, a component floor surface, a bottom component panel, and component wall panels;
at least one small footwear component including a top component panel, a component floor surface, a bottom component panel, and component wall panels;
at least one apparel component including a component floor surface, a component bottom panel, and component wall panels; and
a drainage tray removeably carried by the base component;
wherein the large footwear component includes an opening adjacent a front portion thereof;
wherein the small footwear component includes an opening adjacent a front portion thereof that is smaller than the opening adjacent the front portion of the large footwear component;
wherein the large footwear component, the small footwear component and the apparel component each includes at least one connecting peg extending from a bottom portion thereof:
wherein the top component panel of each of the base component, the large footwear component, and the small footwear component has at least one connecting hole to receive the at least one connecting peg so that the base component, the large footwear component, the small footwear component and the apparel component may be securely and interchangeably stacked in a substantially vertical configuration;
wherein the component floor surface of each of the large footwear component, the small footwear component, and the apparel component includes a drainage port;
wherein the bottom component panel of each of the large footwear component, the small footwear component, and the apparel component includes a drainage coupler positioned to underlie the drainage port;
wherein the drainage coupler on of each of the base component, the apparel component, the large footwear component, and the small footwear component interconnects so as to create a continuous drainage pathway;
wherein a drainage flange is carried by the base component to underlie the drainage pathway to define an inclined surface for distribution of moisture and debris in the drainage tray;
wherein the component wall panels on a rear surface and side surfaces of each of the large footwear component, the small footwear component, and the apparel component have a plurality of holes formed therein; and
wherein the drainage tray includes at least one handle connected thereto.

18. A storage and drying apparatus according to claim 17 wherein the drainage tray includes two handles.

19. A storage and drying apparatus according to claim 18 wherein one handle is formed adjacent a front portion of the drainage tray and one handle is formed adjacent a rear portion of the drainage tray.

20. A storage and drying apparatus according to claim 19 wherein the handles are hingedly connected to the drainage tray.
